(19) United States
(12) Patent Application Publication
(10) Pub. No.: US 2008/0020189 A1
(43) Pub. Date: Jan. 24, 2008

(54) Textile Label and Method for the Production Thereof

(75) Inventors: Stefan Hofmair, Moosburg (DE); Hans-Dieter Schirmer, Altensteig (DE); Reinhard Surkau, Fuerstenfeldbruck (DE)

Correspondence Address: NIXON PEABODY, LLP, 401 9TH STREET, NW, SUITE 900, WASHINGTON, DC, 20004-2128, US

(73) Assignee: Schreiner Group GmbH & Co. KG, Oberschleissheim (DE)

(21) Appl. No.: 10/581,482

(22) PCT Filed: Nov. 24, 2004
(86) PCT No.: PCT/EP04/13337

§ 371 Date: Mar. 21, 2007

(30) Foreign Application Priority Data
Dec. 8, 2003 (DE) 10357193.0

(51) Int. Cl. B32B 3/00; B32B 37/12; C09J 133/04

(52) U.S. Cl. 428/190; 156/325; 156/60; 428/343; 428/355 R

(57) ABSTRACT

The invention relates to a textile label in which the chip (5) of the transponder arrangement is completely embedded in adhesive, which not only provides the connection to the textile base layer (2) and to a similarly textile top label (7), or to the piece of clothing itself, but also provides a highly effective sealing. The adhesive of the adhesive layers (3, 4) is well-absorbed into the tissue structure by the textile base layer (2) and optionally into the further textile layers to give a flexible and resistant material composite which does not tend to delaminate or warp under mechanical, thermal and/or chemical stress. It is of advantage with regard to the long-life and reliability of the transponder arrangement to seal the same completely with adhesive, in other words, not just the chip (5).

The present invention pertains to a textile label, i.e., a label with at least one textile layer, as well as a method for the production thereof. The invention furthermore pertains to a method for labeling garments with labels of this type, as well as a garment provided with such a label. In accordance with habitual language use, the term “textile” used in the following description refers to a fibrous material texture—that may be woven, knitted or realized in the form of a so-called “nonwoven” (nonwoven formed fabric)—wherein the fibers may consist of—spun or non-spun—natural fibers, synthetic fibers or mixed fibers.

Garments as well as other textiles are usually provided with labels of the initially cited type. In this case, the textile label carries information, for example, on the product brand, the manufacturer and/or origin of the garment, care instructions, the composition of the fabric, etc.

It has also been common practice for quite some time to provide garments—as well as other goods—with so-called RFID tags or labels, respectively. RFID is an abbreviation for “Radio Frequency Identification” and refers to the tag or label being equipped with a transponder arrangement that essentially consists of a chip and an antenna. The data content of the chip can be read out in a contactless fashion with the aid of suitable reading devices, wherein the energy supply is realized in an inductive fashion. Such RFID systems are used, for example, as anti-theft devices in department stores, but may also fulfill other functions, particularly in the context of convenient logistics systems, in which the distribution of goods can be monitored easily and with a low susceptibility to errors in any segment of the production and logistics chains. The contactless readout of the transponder chip attached to the respective product also makes it possible to add or delete the product to/from a database within fractions of a second. In contrast to a barcode scanner, the annoying search for the barcode label is eliminated. Depending on the respective configuration, RFID systems also provide the advantage of a variable memory content on the transponder chip. Accordingly, it is not only possible to read out information, but also to transfer data to the chip at different stations while the product passes through logistic processes and, under certain circumstances, even beforehand during its production.

RFID labels frequently are relatively rigid, wherein this rigidity is usually undesirable when the label is used in the textile sector. There also exist textile labels equipped with RFID systems that are much more flexible and therefore less conspicuous with respect to haptic considerations, but these textile labels frequently are not sufficiently protected from environmental influences. In the textile sector, the transponder arrangement should remain undamaged when a garment equipped with the RFID label is washed or cleaned, wherein this requirement, however, cannot be fulfilled with conventional RFID labels.

FR-A-2 823 898 discloses a woven tag that is designed for being attached to a garment and provided with a transponder arrangement bonded thereon, wherein sensitive locations of the chip are protected from environmental influences by means of a silicon sealing mass. However, the silicone seal increases the manufacturing expenditure and does not result in the desired flexibility in all instances, particularly in light of the fact that garment labels ideally should be barely noticeable. Another disadvantage is the risk of damaging the transponder arrangement with a needle puncture when the tag is sewn to a garment.

In light of the above-described shortcomings of the state of the art with respect to certain applications, the present invention aims to develop a textile label with a transponder arrangement that is very flexible and simultaneously highly resistant to high temperatures, water, suds and chemical cleaning agents, wherein said textile label can also be produced in a cost-efficient fashion. The invention furthermore aims to make available a method for manufacturing labels of this type, as well as a method for labeling garments with such labels. Another objective of the invention consists of developing garments equipped with an RFID system that is largely inconspicuous with respect to haptic considerations and the reliable function of which is also ensured after the garment has been washed or cleaned several times.

According to one aspect of the invention, this objective is attained with a textile label according to Claim 1. Preferred embodiments of the inventive textile label may be realized in accordance with Claims 2-15.

In the textile label according to the invention, the chip (and/or, if applicable, other electronic components) of the transponder arrangement is/are completely embedded in an adhesive that not only serves for producing the bond with the textile base layer and a textile upper label or the garment itself, but also ensures that a highly effective seal is produced. The adhesive of the adhesive layers is well absorbed into the fabric structure of the textile base layer and, if applicable, the additional textile layer such that a flexible and highly insensitive material bond is achieved that does not tend to delaminate or warp under mechanical, thermal and/or chemical stress. With respect to the durability and reliability of the transponder arrangement, it is advantageous to completely seal the transponder arrangement with adhesive, i.e., not only the chips. Such an arrangement is preferably used for the predominant majority of possible applications.

The inventive textile label is flexible, printable, washable, water-tight, resistant to water vapor and insensitive to cleaning chemicals, wherein this textile label can also be printed and reprinted, respectively, with conventional printing methods (e.g., ink-jet printing, TTR), realized with a resistance to overpressures up to 30 bar, patched and/or sewn on and produced in the format of conventional textile labels. In this case, not only the chip is protected by being completely embedded in adhesive, but also the antenna such that a highly durable transponder arrangement is realized due to the lack of antenna corrosion. A temperature resistance up to 170 degrees Celsius can be achieved if suitable adhesives are used, wherein polyester adhesive is preferably used for the first adhesive layer and hot-melt adhesive, particularly hot-melt adhesive on the basis of polyester, is used for the second adhesive layer. Depending on the respective application, a programmable chip and/or a chip with a (if applicable partial) write protection and/or with a memory of at least 128 bytes is preferably used for more demanding logistics tasks. For example, the alphanumeric and/or graphic symbols that are preferably situated on the base layer and/or the upper label may be printed on, embroidered or woven into the respective layer.

According to another aspect of the invention, the aforementioned objective is attained with a garment according to Claim 16. The RFID label of such an inventive garment is highly insensitive to external influences, particularly washing at high temperatures or dry-cleaning, without significantly impairing the wearing comfort or the haptic impression of the garment.

According to another aspect of the present invention, the objective is attained with a manufacturing method according to Claim 17. Preferred variations of the inventive method may be carried out in accordance with Claims 18-23. Since the adhesive used not only fulfills a bonding function, but also a sealing function, the method can be carried out in a relatively simple and cost-efficient fashion. If the preferred polyester adhesive is used for the first adhesive layer, in particular, it is possible, according to one particularly preferred variation of the inventive method, to etch the antenna out of a flat or foil-like metal blank, preferably a copper blank, after the metal blank is bonded to the textile base layer. This significantly reduces the risk of damaging the antenna during the production. This arrangement can be subsequently fitted with the chip.

The chip installation, in principle, can be realized with different technical methods. In the so-called flip-chip installation (FC), the connection is produced by means of ACF (anisotropic conductive film), ACP (anisotropic conductive paste), ultrasound, direct contact, thermocompression or similar direct-metallic connecting techniques. A so-called “underfiller” (e.g., a two-component epoxy resin) is normally utilized. In the module installation (MM), the chip is connected to (if applicable sealed) metallic lugs by means of thermocompression, soldering, laser welding or ultrasonic welding; the chip module is crimped on, “clinched on,” bonded, soldered or similarly connected to the remainder of the arrangement. Additional adhesive underneath the module is also advantageous in this case with respect to mechanical stability considerations.

According to another aspect of the present invention, the aforementioned objective is attained with a labeling method according to Claim 24.

Embodiments of the invention are described in greater detail below with reference to the corresponding figures that should be interpreted in a purely schematic fashion. The figures are not true-to-scale, wherein the layer thicknesses, in particular, are greatly exaggerated in the sectional representations for reasons of comprehensibility. Corresponding elements are respectively identified by the same reference symbols in the different figures. The figures show:

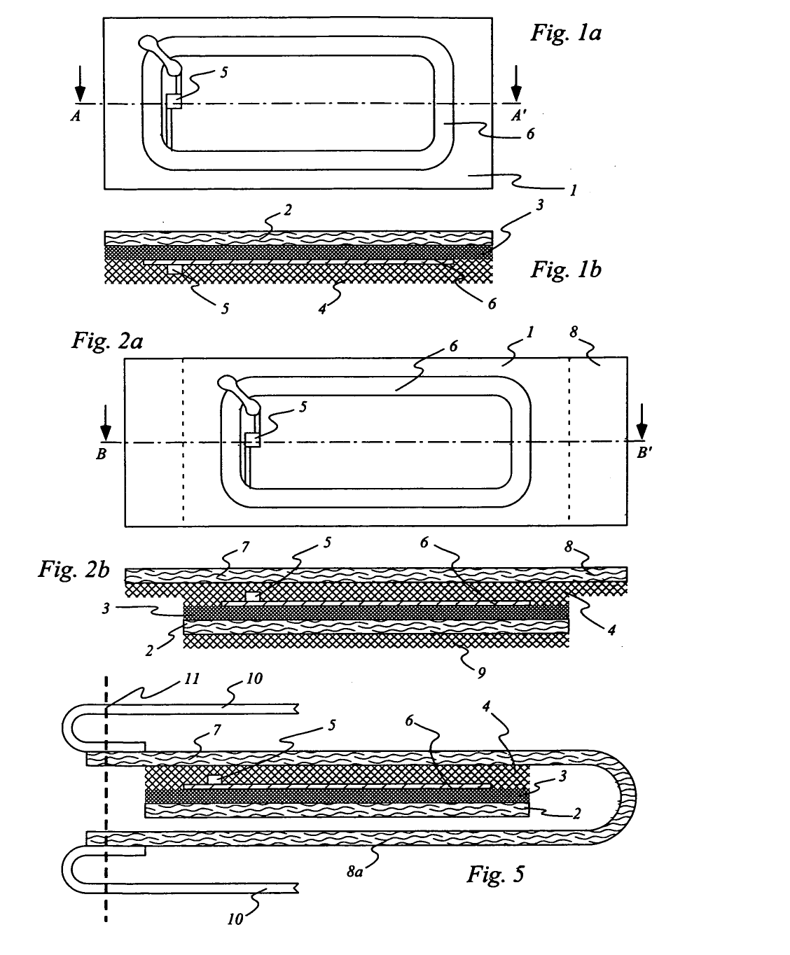

FIG. 1a, a top view of an inventive textile label without an upper label, wherein the normally concealed transponder arrangement is exposed;

FIG. 1b, a cross section through the textile label according to FIG. 1a in the plane of section indicated by the line A-A′;

FIG. 2a, a top view of an inventive textile label with an upper label, wherein the normally concealed transponder arrangement is exposed;

FIG. 2b, a cross section through the textile label according to FIG. 2a in the plane of section indicated by the line B-B′;

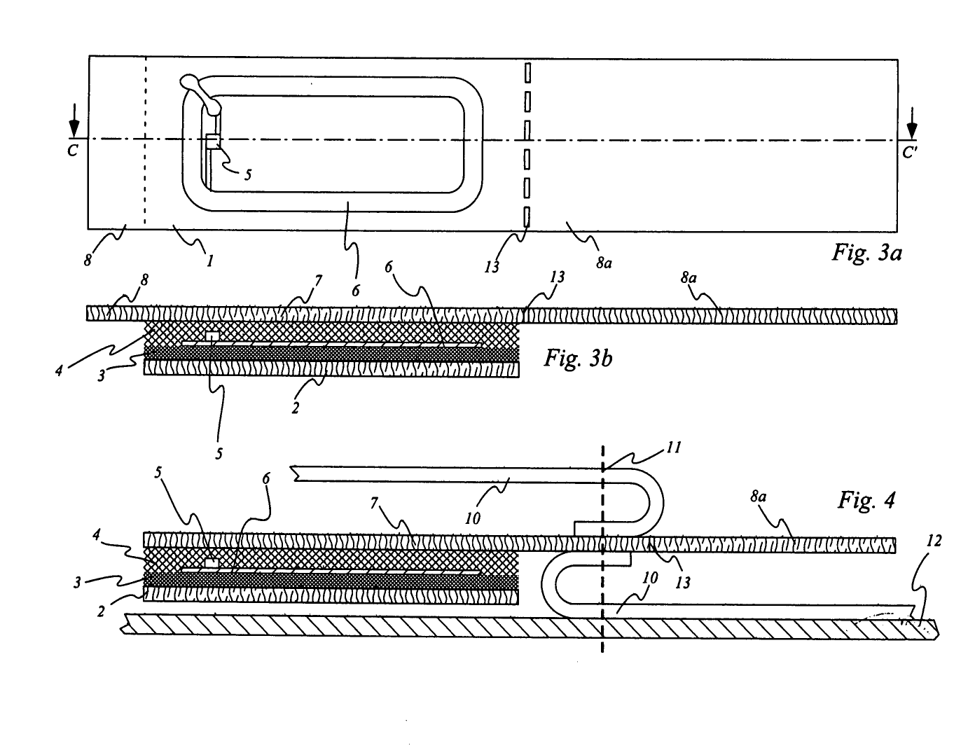

FIG. 3a, a top view of an inventive textile label with an upper label and a removable section, wherein the normally concealed transponder arrangement is exposed;

FIG. 3b, a cross section through the textile label according to FIG. 3a in the plane of section indicated by the line C-C′;

FIG. 4, a textile label that is realized similar to that shown in FIGS. 3a/3b and sewn between the lining and the outer fabric of a garment labeled in accordance with the invention, and

FIG. 5, another textile label that is realized similar to that shown in FIGS. 2a/2b and sewn to a garment labeled in accordance with the invention such that it encloses itself in a pocket-like fashion.

The textile label 1 shown in FIG. 1a and FIG. 1b essentially consists of a printable textile base layer 2, two adhesive layers 3, 4 and a transponder arrangement with a chip 5 and an antenna 6. The antenna 6 and the chip 5 are bonded to the textile base layer 2 by means of the first adhesive layer 3 that preferably consists of polyester adhesive. Instead of a direct-contacted chip 5, it would also be possible to utilize a chip module that is connected to the antenna 6 by metallic bonding. The polyester adhesive provides the advantages of an adequate water resistance as well as an adequate resistance to suds and chemical cleaning agents, a very low sensitivity to fracturing, a high heat resistance and therefore outstanding sealing properties, namely also under adverse ambient conditions. In addition, the material properties of the flexible polyester adhesive advantageously contribute to the flexibility of the adhesive layer 3. Due to the etching resistance of the polyester adhesive, a metal foil (preferably of copper or a suitable copper alloy) can be initially bonded to the base layer 2 in the production of the textile label 1, and the antenna 6 can be subsequently produced by means of etching. This eliminates the problem of having to attach sensitive antenna structures by means of bonding. The (polyester) adhesive layer 3 remains largely unchanged during the etching of the antenna and, in particular, maintains its sealing effect. The second adhesive layer 4 that preferably extends over the entire transponder arrangement advantageously consists of hot-melt adhesive that also has adequate sealing properties under adverse ambient conditions. The hot-melt adhesive also provides the advantage that textile labels according to the invention that are produced in the form of a coherent web can be wound up without liner. The melting point of the hot-melt adhesive can be adjusted in accordance with the respective requirements, wherein this adhesive also has a superior adhesion on textiles. The textile label 1 can be bonded (ironed) to a garment by means of the second adhesive layer 4. The transponder arrangement is then embedded between the two textile layers safely and in a tightly sealed fashion by means of the adhesive layers 3, 4.

The textile label shown in FIG. 2a and FIG. 2b is realized similarly. However, in addition to the textile base layer 2, the two adhesive layers 3, 4 and the transponder arrangement with a chip 5 and an antenna 6, this textile label also features an upper label 7 with regions 8 that protrude over the base layer 2 (and are indicated with broken lines in FIG. 2a), wherein the second adhesive layer 4 extends into these regions. Furthermore, another adhesive layer 9 that preferably consists of hot-melt adhesive analogous to the second adhesive layer 4 is arranged on the side of the base layer 2 that faces away from the chip 5 and the antenna 6. A thusly designed label is practical in instances in which the material, to which the textile label should be bonded, is less suitable for protecting the transponder arrangement in the form of a second textile layer. Alphanumeric or graphic symbols may be printed on, embroidered or woven into the upper label 7.

In another practical embodiment, the regions 8 extending beyond the base layer 2 are free of adhesive and the base layer 2 features no additional adhesive layer 9; in such a design, the textile label can be sewn to the garment or another textile in the regions 8 that protrude over the base layer 2. If a region 8a protruding over the base layer 2 is realized particularly long, the textile label can be sewn to a garment or another textile, for example, the liner 10, in a “pocket-like” fashion as shown in FIG. 5 (with the same reference symbols for the elements as in FIG. 2b). The excessively long region 8 protruding over the base layer 2 is looped around the remainder of the label in this case. The attachment is realized with a single continuous seam 11.

The textile label shown in FIG. 3a and FIG. 3b also features the textile base layer 2, the adhesive layers 3, 4, the transponder arrangement with a chip 5 and an antenna 6 and the upper label 7 with the regions 8, 8a that are free of adhesive and protrude over the base layer 2. The longer region 8a that preferably extends over at least one-third, particularly over at least half the overall length of the base layer 2, can be separated from the remainder of the textile label 1 with the aid of a perforation 13. Separating aids other than a perforation 13 may also be utilized, for example, an incision or even a cutting line that is merely printed on. The separable region 8a provided with (not-shown) alphanumeric or graphic symbols may serve, for example, as a stub. If the sewing is configured accordingly, a perforation 13 of textile labels 1 according to the invention may also serve for separating the label portion that contains the transponder arrangement.

FIG. 4 shows an embodiment of the invention that is designed similar to that shown in FIGS. 3a/3b. FIG. 4, in particular, shows how a garment can be labeled in a particularly advantageous fashion in accordance with the invention. Corresponding elements are once again identified by the same reference symbols. The embodiment shown features only one region 8a that protrudes over the base layer 2. This region is sewn to the lining 10 of a garment by means of a continuous seam 11 in such a way that the portion of the textile label containing the chip 5 and the antenna 6 is situated between the lining 10 and the outer fabric 12. At this location, it is barely noticeable because it is not only arranged invisibly, but also can only be felt if it is deliberately attempted to locate the textile label due to the flexibility and small thickness thereof. The majority of the separable region 8a provided with (not-shown) alphanumeric or graphic symbols protrudes from the lining in order to visually label the garment. If the perforation 13 or another suitable separating aid is configured accordingly, the majority of the region 8a protruding from the lining can be separated, for example, in order to serve as a stub or to increase the wearing comfort of a garment that is worn directly on the skin.

1. A textile label featuring
a textile base layer (2),
a transponder arrangement that is bonded to the textile base layer (2) by means of a first adhesive layer (3), and
a second adhesive layer (4),
wherein the transponder arrangement features an antenna (6) and at least one electronic component that is sealed against environmental influences by means of the first and the second adhesive layer (3, 4).

2. The textile label according to claim 1, wherein at least one electronic component includes a chip (5).

3. The textile label according to claim 1, wherein the second adhesive layer (4) extends over the entire transponder arrangement in a plane fashion.

4. The textile label according to claim 1, wherein the first adhesive layer (3) consists of a polyester adhesive.

5. The textile label according to claim 1, wherein the second adhesive layer (4) consists of a hot-melt adhesive.

6. The textile label according to claim 1, wherein the antenna (6) consists at least predominantly of copper.

7. The textile label according to claim 1, wherein the base layer (2) features at least one of the group consisting of graphic and alphanumeric symbols.

8. The textile label according to claim 1, wherein an additional textile layer is bonded to the remainder of the label by means of the second adhesive layer (4).

9. The textile label according to claim 8, wherein the additional textile layer consists of an upper label (7).

10. The textile label according to claim 9, wherein the upper label (7) features at least one of the group consisting of graphic and alphanumeric symbols.

11. The textile label according to claim 9, wherein the upper label (7) protrudes over the base layer (2) on at least one side.

12. The textile label according to claim 11, wherein at least a portion of the region (8, 8a) of the upper label (7) that protrudes over the base layer (2) can be separated from the remainder of the label.

13. The textile label according to one of claim 11, wherein the region (8, 8a) of the upper label (7) that protrudes over the base layer (2) is sewn to a garment.

14. The textile label according to one of claims 11, wherein the region (8, 8a) of the upper label (7) that protrudes over the base layer (2) is bonded to a garment.

15. The textile label according to claim 8, wherein the additional textile layer consists of part of a garment.

16. A garment featuring a label according to claims 1.

17. A method for manufacturing a textile label comprising at least the following steps
applying a first adhesive layer (3) on a textile base layer (2),
attaching a transponder arrangement featuring an antenna (6) and at least one additional electronic component (5) to the first adhesive layer (3) and
applying a second adhesive layer (4) such that it covers and seals at least the additional electronic component (5).

18. The method according to claim 17, wherein the second adhesive layer (4) is applied such that it covers the entire transponder arrangement.

19. The method according to claim 17, wherein the attachment of the transponder arrangement consists of bonding on a metal foil section and subsequently etching the antenna (6) out of the metal foil section.

20. The method according to claim 19, wherein a metal foil section is used that predominantly consists of copper.

21. The method according to claims 17, wherein the first adhesive layer (3) is produced with polyester adhesive.

22. The method according to claims 17, wherein the second adhesive layer (4) is produced with hot-melt adhesive.

23. The method according to one of claims 17, wherein the bonding to an additional textile layer is realized with the aid of the second adhesive layer (4).

24. A method for labeling a garment, wherein a label according to claims 1, is attached to a garment by one of the group of procedures consisting of sewing and bonding.
